(19) United States
(12) Patent Application Publication
(10) Pub. No.: US 2003/0095832 A1
(43) Pub. Date: May 22, 2003

(54) Double locking mortise joint

(76) Inventor: Alex P. Weaver, San Jose, CA (US)

Correspondence Address: Otto O. Lee, Esq., Intellectual Property Law Group LLP, Suite 1205, 12 S. 1st. St., San Jose, CA, 95113, US

(21) Appl. No.: 09/997,494

(22) Filed: Nov. 19, 2001

(51) Int. Cl. B25G 3/36

(52) U.S. Cl. 403/403

(57) ABSTRACT

The invention discloses a double locking mortise joint for joining together two members by pressing two interfitting members together. The invention creates a joint that is structurally rigid, reliable, easy to assemble and disassemble, cost efficient and aesthetically pleasing. Extra joint pieces, adhesives and fasteners are not required with this invention. The invention provides vertical and shear strengths to the members being joined. The double locking mortise joint is formed when the mortise and gusset of a first member is interlocked with the mortise of a second member, thereby forming a durable joint which can be embodied as each of the four joints connecting a table top to its legs.

### BACKGROUND

This invention relates generally to the joint art and more specifically to a double locking mortise joint for joining together two members by merely pressing two interfitting members together.

There are many instances which require parts to be detachably joined with a joint which is structurally rigid, reliable, easy to assemble and disassemble, yet aesthetically pleasing and greatly reduces cost of manufacturing. One application in which such joint is desirable is in joining the legs and tabletop component of a high-end modular table unit. Other applications are also possible.

One problem with currently available joint systems is that they are time consuming to assemble and/or disassemble, and they may require use of extra tools such as a clamp and additionally an adhesive or a glue to secure the joint for structural integrity.

A problem with using an adhesive or glue is that the resulting joint may not be particularly aesthetically pleasing. Excess adhesive or glue, especially when such adhesive or glue is applied without precision and careful craftsmanship, may result in messy and poor looking finishing joint work. Using an adhesive or glue is also problematic because over time, the adhesive or glue may become weak in bonding strength. Using an adhesive or glue also adds to the cost of manufacturing the joint.

Another problem with currently available joint systems is that some require extra pieces for forming the joint, wherein one or more interlocking pieces are connected to the members to be joined. This not only makes the assembly and/or disassembly of the joints relatively time consuming, but such extra pieces add to the cost of manufacturing.

Yet another problem with currently available joint systems is that because of their very nature, some joints have limited application. For instance, some joints may provide good vertical strength, but little or no sheer strength, especially with absence of additional support pieces or glue to increase structural integrity.

One example of a currently available joint system is an interlocking Joint. Interlocking joints are used for coupling together two members at a predetermined angular relationship, such as in joining fronts, backs, and sides of drawer, usually at right angles. A male joining means is coupled to the first member and has an outwardly upstanding male portion extending from the first member at the predetermined angle. A female joining means is coupled to the second member and the female joining means has walls defining a male portion receiving cavity. The male portion is inserted into the cavity of the female joining means where it may be frictionally retained to provide a removable coupling between the members.

Interlocking joints require extra pieces other than the members of the joint pieces to be joined, such as the male and female joining means described above, and therefore adds to the cost of manufacturing a particular product embodying the joints. Furthermore, when interlocking joints such as the one above are used, multiple pieces are required to form a joint, and this makes assembly and/or disassembly of the joint relatively time consuming. Another problem with interlocking joints is that such joints may not provide adequate structural rigidity necessary for joints requiring substantial vertical and sheer strength, such as the junctions between a tabletop and its legs. This is especially true when the male and female joining means described above are made of resilient material such as rubber or plastic. Lastly, interlocking joints are not always aesthetically pleasant because of the male and female joining means which do not necessarily coordinate with the rest of a particular furniture, woodwork, or any other piece of object incorporating such joints.

Yet another example of an existing joint system is a structural joint. A structural joint is formed by a rib of one structural member being fitted into a groove of a second structural member. Such structural joint may have a portion beveled at an angle of 45° which includes a mortise in the form of a generally cylindrical groove being joined to a second structural member having a portion beveled at an angle of 45° which includes a tenon in the form of a generally cylindrical rib. These beveled portions result in an abutting relationship by a joint formed by the rib being fitted in the groove.

One critical shortcoming of a structural joint such as the one described above is that such joint, while providing relatively sufficient vertical support along the direction of the joined members, does not provide adequate sheer strength, i.e., a structural support perpendicular to the plane of the members being joined by such joint. Therefore, if such structural joint mechanism were to be used to join a tabletop and its legs, while the resulting table may possess adequate vertical strength, once the table is shaken side to side, its legs may easily give in and the legs may fall apart from the tabletop.

Another example of an existing joint system is a lap joint. A lap joint is designed to form a flush finish, which results in relatively small wood surfaces being “lapped” or overlaid on top of each other to form the joint. The lap joint is made of a board with a dado cut out of it and an opposing board with an identical dado cut out of it at the same depth, and “lapped” or overlaid on top of each other at the respective dado cutouts, thereby forming an “X”. To provide strength to the lap joint, multiple laps must be incorporated in the lap joint, or the joints must be secured with glue, clamps, or mechanical fasteners. A lap joint, if incorporated into a table, would provide no shear strength to the table due to its lapped nature. Mechanical fasteners, while being able to provide strength to the lap joint, would not be aesthetically pleasing. For example, a table that uses lap joints to join the legs to the table surface would require mechanical fasteners to be added to the leg joints from the outside, destroying the overall aesthetic appearance of the table. Furthermore, gluing of the joints and sanding after final assembly will be required for a finished look.

Still another example of existing joint systems is a dovetail. Formation of the tapered tongues and grooves in a dovetail joint is rather complicated and expensive, usually requiring special machines. A conventional dovetail joint must be glued together and then clamps are required during the setting of the glue as with other types of glued joints. Production is limited by the work involved in the preparation of the interfitting parts, by the manipulations necessary to fit them together, and by the setting time of the glue. Although dovetails are generally useful for forming an I-beam or truss section, they provide no side-to-side, sheer strength.

Modified dovetails improve upon conventional dovetail joints. A pair of parallel tongues are pressed into grooves of uniform width in the other member. The grooves are inclined relative to each other from top to bottom and bend the tongues out of parallelism, thereby locking them in the grooves.

However, the same problem remains that such dovetail joints lack ease of assembly and disassembly, due to multiple numbers of recesses and protrusions that must be aligned and fitted together to form a final dovetail joint. Furthermore, as with conventional dovetails, the tongues in modified dovetail joints are difficult to machine, adding to expense of manufacture.

A finger joint is similar to the times of a fork. Two opposing sides interlock together to form a strong joint. However, it only serves to lengthen two pieces of wood together. The finger joint has a shortcoming in that when two boards are joined together, the weight from the two boards on either side of the joint puts stress on the joint and weakens the structural integrity of the joint. A finger joint is mainly used for making moldings and trims. This type of joint provides no shear strength. The molding formed by a finger joint is always fastened to a wall, ceiling, or other flat and strong substrate to maximize its strength. An adhesive must be used to secure the joint.

### SUMMARY

Therefore, an important object of the current invention is to provide a detachable joint which is structurally rigid, providing vertical and shear strengths to the members being joined. An additional object of the present invention is to provide a detachable joint which is easy to assemble and disassemble. Another object of the present invention is to provide a detachable joint which is aesthetically pleasing in design. It is also the object of the present invention to provide a detachable joint which is simple in design and which greatly reduces economy of manufacturing. Still another object of the present invention is to provide a detachable joint which does not require extra pieces or adhesives for structural integrity.

### DRAWINGS

These and other features, aspects, and advantages of the present invention will be better understood from the following drawings, description and appended claims, where:

FIG. 1 is a perspective view of a table embodying the double locking mortise joints of the present invention

FIG. 2 is a top plan view thereof;

FIG. 3 is a bottom plan view thereof;

FIG. 4 is a side elevational view thereof; the opposite side being identical in appearance; and

FIG. 5 is a front elevational view thereof; the rear being identical in appearance;

FIG. 6 is a perspective view of the table in FIG. 1 in a disassembled state;

FIG. 6A is an exploded view of part A of FIG. 6;

FIG. 7 is a perspective view of a cut-out portion of a tabletop embodying the second member of a mortise joint of the present invention;

FIG. 8 is a perspective view of a table leg embodying the first member of a mortise joint of the present invention.

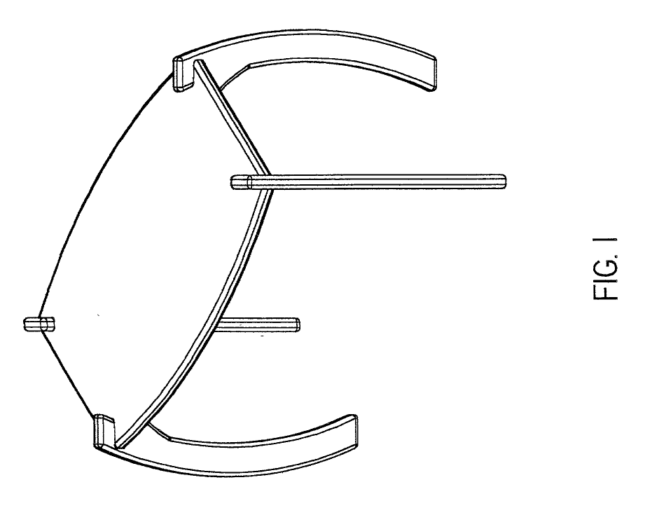

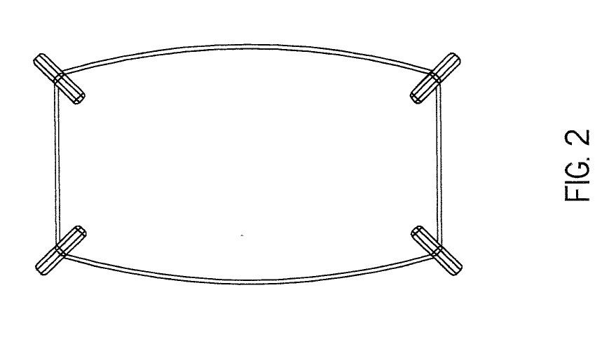

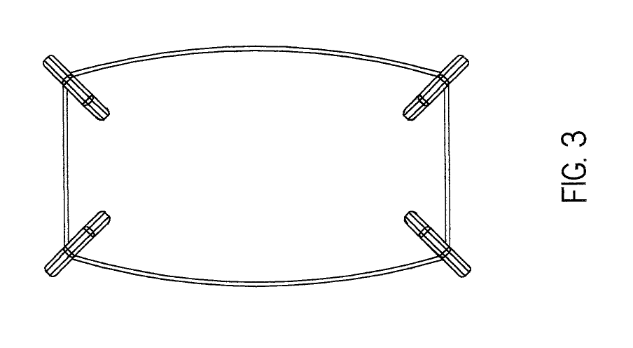

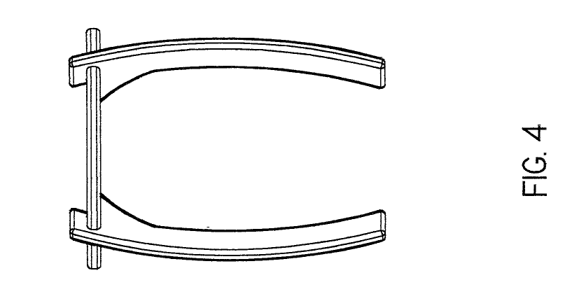

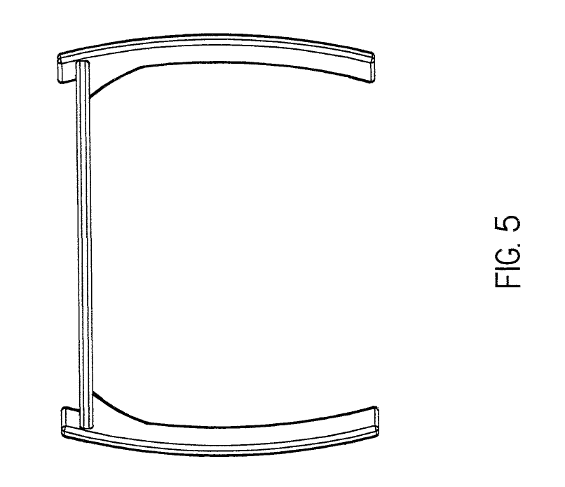

### DETAILED DESCRIPTION OF THE INVENTION

The following discussion describes in detail one embodiment of the invention and several variations of that embodiment. This discussion should not be construed, however, as limiting the invention to those particular embodiments. Practitioners skilled in the art will recognize numerous other embodiments as well.

For the purpose of illustration, the novel joint of the present invention is hereinafter described in the context of a highly stylistic, self-assembled wood table. Such table may be a large dinner table, a smaller coffee table, or any other type of table. Such self-assembled table should ideally be relatively lightweight yet durable, inexpensive, quick and easy to assemble and/or disassemble and should allow a wide variety of configurations to be constructed with relatively few basic components. At the same time, such table should be highly aesthetic and pleasing to the eye as a piece of elegant furniture. It can be readily appreciated that a good joint for connecting the components of a table will have application in many fields where it is desirable to quickly and securely detach and connect members together.

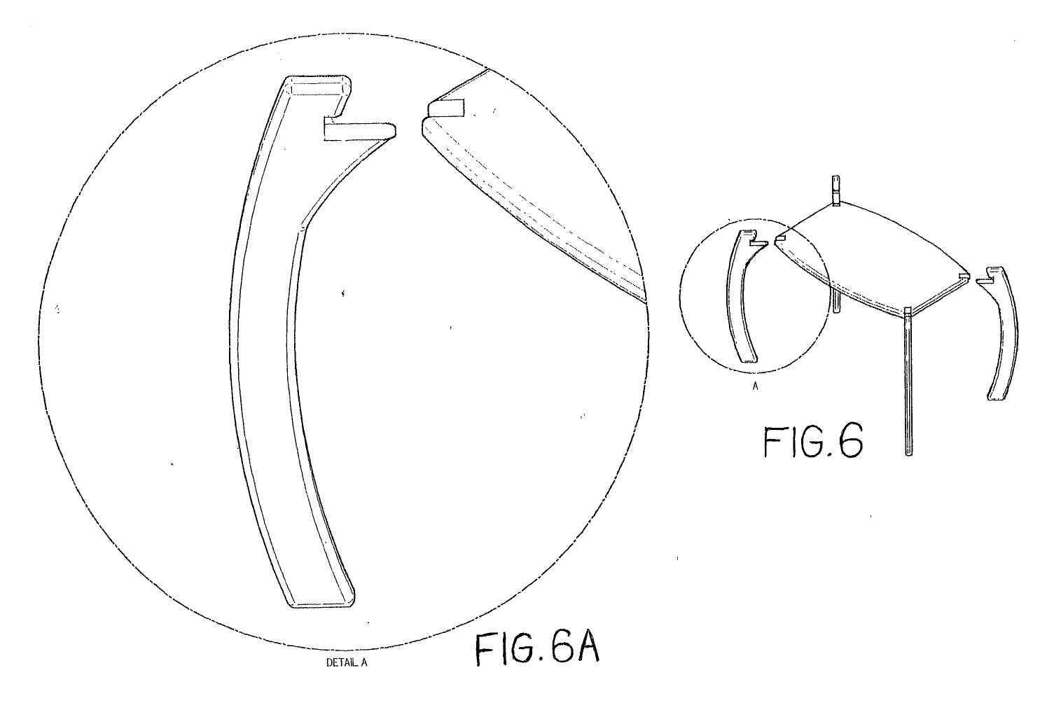

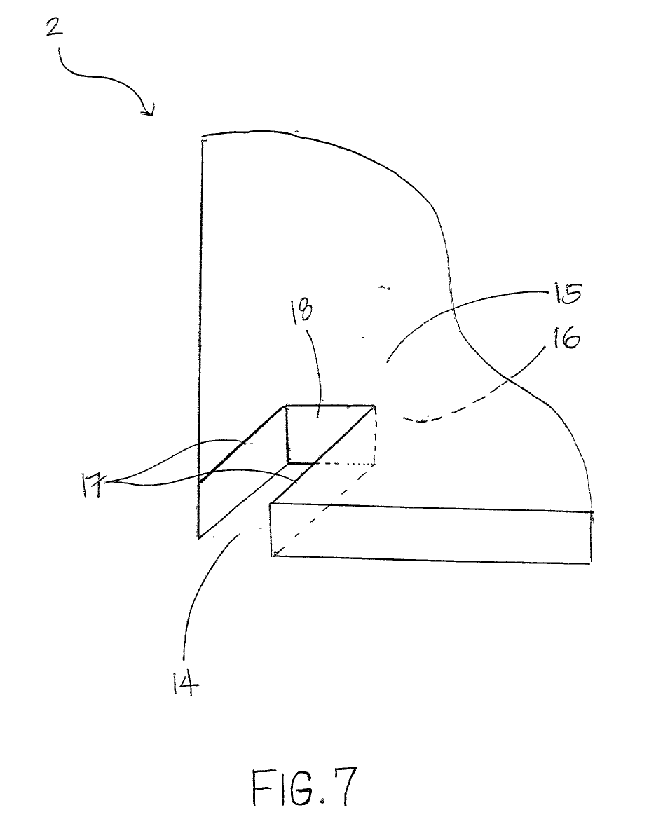

As shown in FIG. 6A, a double locking mortise joint 21 comprises a first member 1 and second member 2 which are rigidly and snuggly yet removably joined together. The first member 1 as in FIG. 7, can be shaped like a table leg and comprises of a top end 3, an inner side 19 and an outer side 20. The inner side 19 and outer side 20 are substantially parallel to each other or may have the same curvature.

The top end 3 comprises a first mortise 4 and a gusset 5, both formed generally perpendicularly with respect to the vertical axis 6 of the first member 1. The gusset 5 comprises of a gusset top 7 which extends generally perpendicarly outward from the first mortise 4 of the first member 1. The first mortise 4 comprises of a head bottom 8 parallel to and above the gusset top 7, a first mortise end 9 generally parallel to the first member 1, a first contact surface 10 and a second contact surface 11 next to the first mortise end 9.

The head bottom 8 is generally not longer in length than the length of the gusset top 7. The first mortise end 9 connects the head bottom 8 to the gusset top 7. The first mortise 4 further comprises a first mortise corner 12 and a second mortise corner 13. The first mortise corner 12 is located at the junction of the head bottom 8 and the first mortise end 9. The second mortise corner 13 is located at the junction of the first mortise end 9 and the gusset top 7. Either one or both of the mortise corners 12, 13 can be square-edged. Further, either one of both of the mortise corners 12, 13 can be rounded.

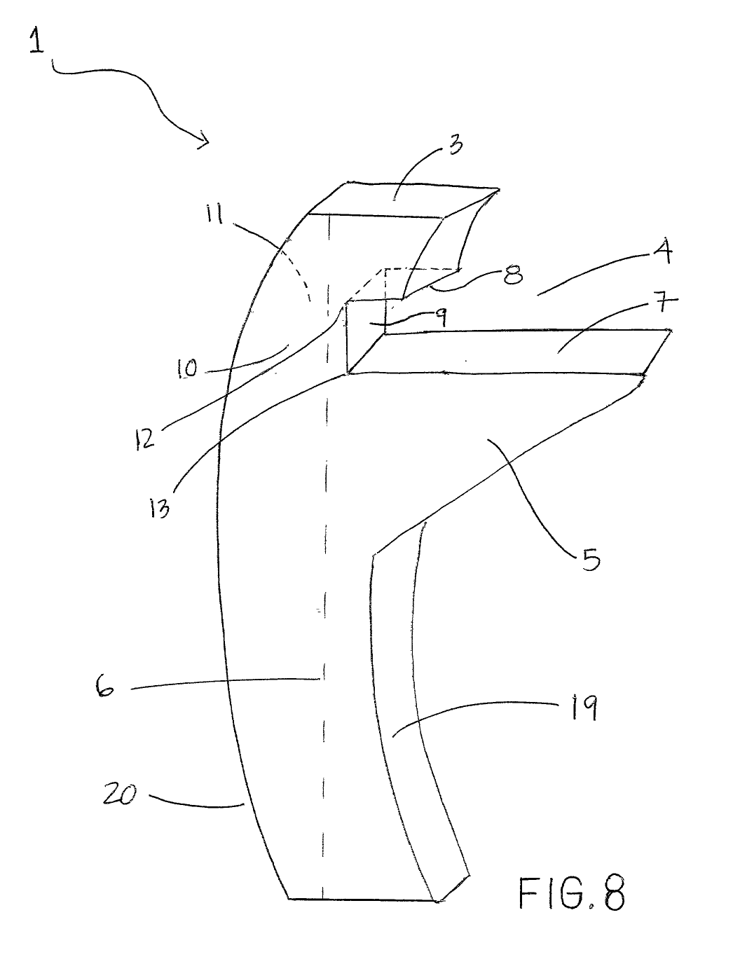

The second member 2, as in FIG. 8, can be shaped as the corner of a tabletop and comprises of a second mortise 14, a top surface 15 and a bottom surface 16. The said second mortise 14 comprises of two opposing sides 17 which are generally parallel to each other, and a second mortise end 18 that connects the two opposing sides 17. The top surface 15 and bottom surface 16 is located next to the second mortise end 18.

The double locking mortise joint is thus formed when both the gusset top 7 and head bottom 8 are fitted between the two opposing sides 17 of the second mortise 14. The head bottom 8 will thereby rest on the top surface 15, the gusset top 7 will rest beneath the bottom surface 16, and the two opposing sides 17 will fit over the first and second contact surfaces 10, 11.

The double locking mortise joint as described above can be used for the easy connection and detachment of various members made of different materials. In the preferred embodiment the invention is made out of wood and used in a highly stylistic, self-assembled wood table. By interlocking the two members having the double locking mortise joint, no adhesive or fasteners are required.

One advantage of the present invention is that it allows for quick as well as secure assembly of members. Assembling and disassembling other joint systems is often time consuming, requiring the use of extra construction tools and materials such as adhesives, fasteners or other required joint pieces. By using the present invention, assembly time will be greatly reduced because no tools, fastening material, or joint pieces are necessary. One needs only to engage the two mortises together to achieve the desired connection. The same ease is apparent when disassembling the joint. One needs only to manipulate the two members apart, i.e., the table leg from the tabletop corner. Again, the use of tools is not required, thereby saving time and effort.

Accordingly, the ease in assembly and disassembly of this invention leads to reduced cost of implementing the invention in a joint system. As mentioned, there is no expense in purchasing assembly tools or fasteners. Because of the ease of disassembly, transporting and storing such members become easier as well as cost effective. There is less chance of damaging furniture that uses the invention when transporting it in and out dwellings in a disassembled state. Further, there is less chance of damaging door frames and walls of these dwellings when transporting the furniture into rooms.

Moreover, the simple design of the present invention results in manufacturing cost savings. The invention requires no additional joint pieces, fasteners or adhesives.

Another advantage of the present invention is structural integrity of the resulting joint. Some joints have limited application and may provide good vertical strength, but little or no shear strength if not additionally supported with other support pieces or adhesives. Over time, other joint connections which use adhesives or other fasteners may become worn and weak in strength, e.g., glue may crack, fasteners may rust. However, the present invention overcomes any of those shortcomings because no extraneous connecting material is necessary.

Furthermore, not only does the present invention have the advantages of a quick, easy, cost effective and secure joint connection, but it also creates an aesthetically pleasing product. The double locking mortise joint is manufactured with a pleasant and stylish design. Because it uses no extra joint pieces or fasteners, the invention achieves an appearance of high quality craftsmanship. Without the use of messy adhesives and possibly unaligned connections, the present invention has a very neat and clean form. It is a simple yet visually impressive invention.

What is claimed is:

1. A double locking mortise joint comprising:
(a) a first member having:
i) a first mortise being formed generally perpendicularly with respect to an axis of said first member, said first mortise having:
1) a gusset top extending generally perpendicularly outward with respect to said axis of said first member;
2) a head bottom opposite to and generally parallel to said gusset;
3) a first mortise end being generally parallel to said axis of said first member and connecting said gusset top and said head bottom;
ii) a first contact surface and a second contact surface next to said first mortise end;
(b) a second member having:
i) a second mortise having two opposing sides being generally parallel to each other, and a second mortise end connecting said two opposing sides;
ii) a top surface and a bottom surface next to said second mortise end;
whereby said first member and said second member are rigidly and snuggly yet removably joined together at the first mortise and second mortise by fitting said gusset top and said head bottom between said two opposing sides of said second mortise, such that said head bottom extends onto said top surface, said gusset top extends onto said bottom surface, and said two opposing sides extend onto said first contact surface and said second contact surface.

2. The double locking mortise joint of claim 1, wherein said head bottom is not longer in length than said gusset top.

3. The double locking mortise joint of claim 1, wherein said first mortise further comprises a first corner and a second mortise corner, said first mortise corner being located between said first mortise end and said head bottom, said second mortise corner being located between said first mortise end and said gusset top, and at least one of said two mortise corners is square-edged.

4. The double locking mortise joint of claim 3, wherein both of said two mortise corners are square-edged.

5. The double locking mortise joint of claim 3, wherein both of said two mortise corners are rounded.

6. The double locking mortise joint of claim 1, wherein said first member is a table leg, and said second member is a corner of a tabletop.

7. The double locking mortise joint of claim 6, wherein said first member further comprises an inner side and an outer side, said inner side and said outer side being substantially parallel to each other.

8. The double locking mortise joint of claim 7, wherein said inner side and said outer side have a same curvature.
